(19) United States
(12) Patent Application Publication
(10) Pub. No.: US 2015/0114431 A1
(43) Pub. Date: Apr. 30, 2015

(54) AIR BLAST WIPER SYSTEM AND METHOD

(71) Applicant: Glacial Blaster, Inc., Grand Rapids, MI (US)

(72) Inventor: Frederick J. Manning, JR., Grand Rapids, MI (US)

(73) Assignee: Glacial Blaster, Inc., Grand Rapids, MI (US)

(21) Appl. No.: 14/068,922

(22) Filed: Oct. 31, 2013

(51) Int. Cl. B60S 1/60

(52) U.S. Cl. CPC B60S 1/60
USPC 134/18; 15/250.001

(57) ABSTRACT

An air blast wiper system and method for removing snow from a vehicular marker light includes an automatic control system connected to an air reservoir for regulating a flow of air into predetermined intermittent gushes of air. Supply tubing distributes air from the automatic control to a predetermined location on the vehicle. A uniquely oriented truncated conical nozzle is used for directing the intermittent gushes of air from the supply tubing toward a surface of the warning light in order to maintain the warning light in a visible state when the vehicle is driving in a snowy or icy conditions. The automatic control includes a pressure switch for determining if the pressure in the air reservoir is below a predetermined level and for preventing use of the blast wiper system to enable the vehicle's air braking system to remain operative.

### FIELD OF THE INVENTION

The present invention relates generally to vehicular lighting and more particularly to a system for removing environmental residue, such as snow and ice, from vehicle marker lighting.

### BACKGROUND

It is important to keep vehicular lighting clear when operating the vehicle under snowy road conditions. The vehicle tail lighting enables others to see the red and/or white lights at the rear of the vehicle when in operation. These lights could be any combination of brake/tail, running, back-up, strobe or other types of lighting as may be found on street and highway snow plows operated by City, County and State agencies charged with winter road maintenance. These lights can also be found on the rear of commercial semi-tractor trailers and commercial tanker vehicles such as milk, gasoline and propane haulers. However, operation of these vehicles in snow and ice often allows snow and/or ice to build on the face or lens of the light. This can obstruct the view of the light to those at the rear of the vehicle which can lead to unsafe operation at night or when the vehicle is in low light conditions due to heavy or blowing snow.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a perspective view of the rear of a snow removal truck using the air blast wiper system in accordance with an embodiment of the invention.

FIG. 2 is a magnified view of the blast wiper system shown in FIG. 1.

FIG. 3 is a perspective view of the rear of a lighting panel in accordance with an alternative embodiment of the invention.

FIG. 4 is magnified view of a nozzle assembly used in connection with embodiments of the invention.

FIG. 5 is a magnified view of a truncated nozzle used in connection with an embodiment of the invention.

FIG. 6 is a block diagram illustrating the blast wiper system in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a blast wiper system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof; are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

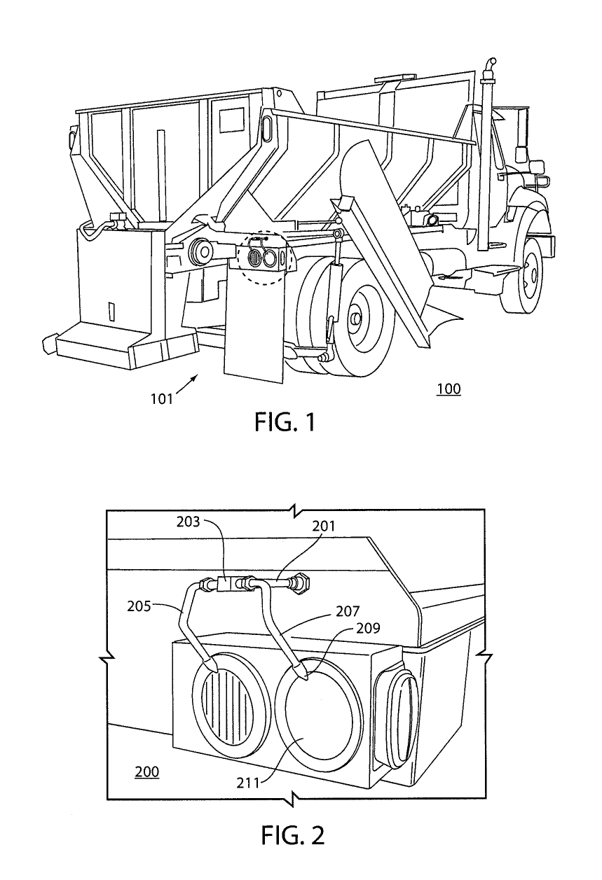

FIG. 1 is a perspective view of the rear of a snow removal truck using the air blast wiper system in accordance with an embodiment of the invention. The truck 100 is shown from a rear corner where the piping, nozzles and air delivery of the snow removal system 101 is placed at or above the truck's taillight assembly. The truck's taillight assembly may use a light emitting diode (LED) light source or the like. Those skilled in the art will recognize that when LEDs are used, heat may not be sufficiently generated, as would an incandescent light source, to melt snow, ice or other environmental residue from the surface of the taillight lens.

FIG. 2 illustrates a magnified view of the piped delivery system shown in FIG. 1. The piped delivery system 200 includes a feed tube 201 that is fixedly connected to the body of the truck or other vehicle. The feed tube 201 is positioned above the vehicle's tail light and is generally a substantially straight section of metallic pipe or plastic tubing of ¼ inch diameter or greater. A supply tube such as feed tube 201 supplies compressed air and/or fluid to a T-connector 230. The T connector 203 feeds one or more delivery tubes 205 which are bent and/or routed downwardly toward the top portion of the taillight lens 211. The delivery tubes may be soldered or mechanically connected with fluid connectors to the T-connector 203 using threads or other mechanical means. At the end of the feed tube 205, a nozzle 209 is used to disperse the compressed air or compressed air with fluid onto the surface of the tail light lens. The nozzle 209 has a truncated conical shape so as to direct a blast of air in more of a disbursed manner enabling snow, ice or other environmental residue to be easily removed from the surface of the lens 211 with the blast of air. Alternatively, the delivery tube 205 and nozzle 209 may be a single unitary piece where the nozzle 209 is integrally formed using an approximately 6 inch section of ¼ inch copper tube with the nozzle permanently affixed to an end of the tube. Although a brake light and reverse light are shown in FIG. 2, each with its own nozzle 209, it should be evident to those skilled in the art that the taillight assembly may include any number of lights and additional T-connectors 203 or other fittings could be used with nozzles to clear snow and other residue from the surface of the lens.

In use, the nozzle 209 is positioned at a top or upper edge of the lens in relation to the ground. The nozzle 209 is optimally positioned at approximately a 30 degree angle relative to the lens surface such that the snow and other environmental residue on the lens surface will be blown in a downward direction, away from other lenses in the taillight assembly, toward the ground.

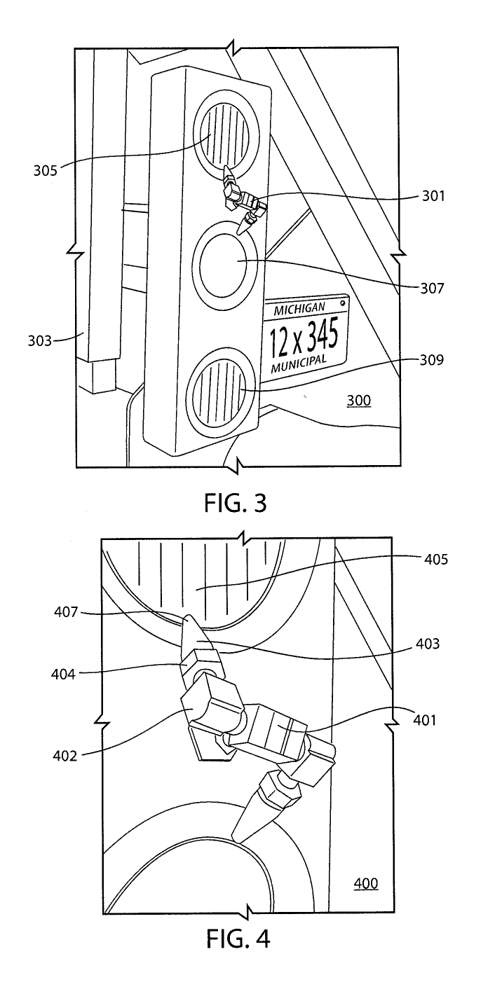

FIG. 3 is a perspective view a lighting panel in accordance with an alternative embodiment of the invention. As seen in FIG. 3, the lighting panel 300 is generally rectangular in shape and includes three lights in the panel housing. In this embodiment, the blast wiper system includes a T-connector 301 that is mounted to the housing between a first light 305 and second light 307. The T-connector 301 includes nozzles mounted by threaded connection directly into the T-connector. As described herein, the nozzles include a body with an attached head-end having a truncated conical shape. The nozzle(s) are typically positioned at the edges of a lens at approximately a 30 degree angle relative to the lens surface. Positioning the lens in this manner enables an air blast to remove any snow or environmental residue from the lens surface. Although not shown in FIG. 3, a second T-connector can also be mounted between the second light 307 and the third light 309 for removing snow from the lens of the third light 309.

FIG. 4 is magnified view of a nozzle assembly used in connection with embodiments of the invention. The nozzle 400 includes a T-connector 401. A nozzle adapter 402 is threaded into the T-connector 401 at both of its ends. A truncated nozzle 403 includes a body 404 and head 407. The truncated nozzle 403 is positioned at approximately a 30 degree angle to the surface of a lens 405. The truncated nozzle 403 works to evenly distribute a gush and/or predetermined intermittent blast of air to the surface of the lens 405 for keeping the surface of the lens unobstructed from environmental residue such as snow and ice.

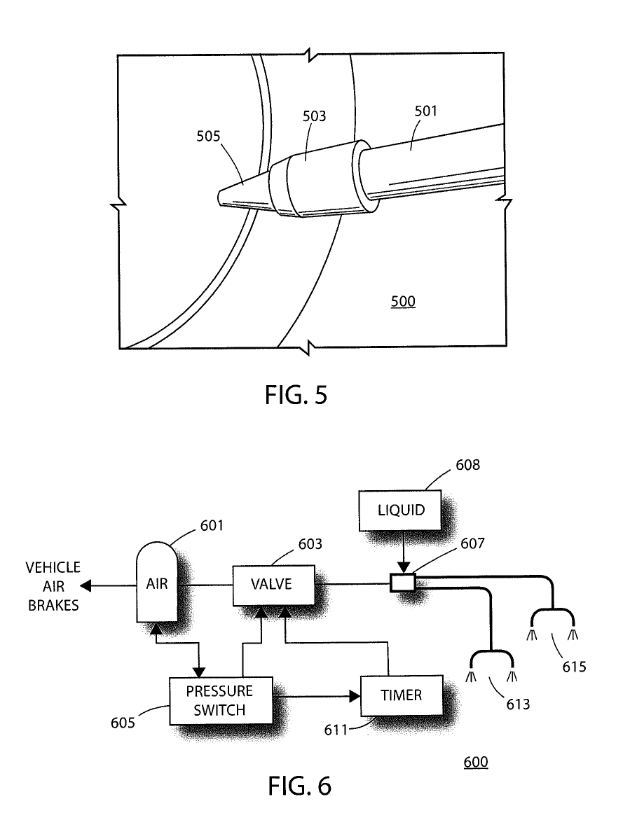

FIG. 5 is a magnified view of a truncated nozzle used in connection with an embodiment of the invention. The nozzle 500 includes a supply tube 501, body 503 and the truncated conical head 505 that works to evenly distribute air and/or air and fluid to the surface of the marker light lens.

FIG. 6 is a block diagram illustrating the blast wiper automatic control system in accordance with an embodiment of the invention. The control system 600 includes an air reservoir 601 that is typically used in connection with the vehicle's air braking system. Thus, the output of the air tank or reservoir feeds the vehicular air brakes while also supplying compressed air to the blast wiper system as described herein. A pressure switch 605 monitors the vehicle's system air pressure. If the system pressure falls below approximately 85 PSI, the air blast wiper system 600 will not operate again until it is cycled i.e. reset, by turning it off and then on again. If the air blast wiper system is reset and the air system still lacks adequate pressure, the air blast system will not function. The air blast wiper system will be operational when powered on and adequate air pressure is present. This gives air system priority to the air brake system, ensuring there is adequate air pressure available for air brake operation. The reservoir 601 supplies compressed air to an air valve 603. The pressure switch 605 monitors system air pressure such that when the pressure in the reservoir 601 falls below a predetermined threshold, valve 603 will not operate to supply compressed air to the blast wiper system 600. The fluid reservoir 609 is typically filed with an alcohol based, anti-freeze type fluid or the like suitable for cleaning exterior glass and lighting surfaces. The reservoir 609 is also made of a durable and generally clear material which allows for easy determination of the state of fill of the reservoir.

When pressure switch 605 determines that there is adequate pressure available to operate the system, then timer 611 will supply power to valve 603. The settings of timer 611 determine both the on and off times of the valve 603. For example, the compressed air from the air reservoir 601 may only be supplied or “gushed” in predetermined amounts based on timing supplied to the valve 603. When the valve 603 is in an open state, compressed air from the air reservoir 601 is supplied to the nozzles 613, 615. When the valve is cycled, an anti-freeze fluid can also be introduced downstream of the compressed air stream which emanates from the liquid reservoir 608 and supplied though a manifold 607. Other controls incorporated in the invention include the ability to remotely power the invention on and off, such as from the cab of a snowplow. Also, a lighted manual over-ride button also in cab, in proximity to the power switch, may serve to indicate that the system is “on” and that suitable air pressure is available for its operation.

Additionally, those skilled in the art will further recognize that other aspects of the invention include a second valve that may be used to control output of the fluid reservoir 609. Further, the fluid reservoir 609 can also include a heater for the fluid and a temperature sensor for automatically activating the system or a heater for heating the liquid in the fluid reservoir. Moreover, a liquid level float switch can also be used to inhibit operation of the fluid reservoir when the fluid level in the reservoir is below a predetermined level. Finally, the system may be also controlled by the vehicle lighting such that the air blast wiper system is activated only upon activation of the vehicle hazard lights and/or tail lights.

The present application is directed to various embodiments of an air blast wiper system for removing snow and/or environmental residue from an LED or other style of marker light lens surface used for vehicular lighting. The system may be a set of individual parts such as a kit for installation by the owner or skilled mechanic. The air blast wiper system can also include a fluid reservoir for providing an anti-freeze fluid with the compressed air stream. An automatic control system is used for regulating a flow of air from the air reservoir into predetermined intermittent gushes of air. Supply tubing is used for separately delivering and/or distributing air from a T-connector to an upper edge of one of more lenses used with vehicular marker lighting. A conical nozzle operates to direct the intermittent gushes of air and anti-freeze fluid from the supply tubing toward a surface of the first lens and second lens at approximately a 30 degree angle relative to the surface of the first lens and second lens to maintain the warning light of the vehicle in a visible state when the vehicle is driving in a snowy condition. The automatic control system includes one or more pressure switches for determining if the pressure in the air reservoir used in the vehicle air braking system is below a predetermined level. The pressure switches prevent use of the blast wiper system to enable the vehicle's air braking system to remain operative when pressure within the air reservoir is below a predetermined threshold. Hence, the air blast wiper system may be configured differently depending on user need and will include one or more of the following components: an air reservoir; valve, timer; pressure switch and/or truncated conical nozzle.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An air blast wiper system for removing snow from at least one marker light of a vehicle, comprising:
an automatic control system connected to the air reservoir for regulating a flow of air into predetermined intermittent gushes of air;
supply tubing for distributing air from the automatic control to at least one predetermined location on the vehicle;
at least one truncated conical nozzle for directing the intermittent gushes of air from the supply tubing toward a surface of the warning light for maintaining the warning light of the vehicle in a visible state when the vehicle is driving in a snowy condition; and
wherein the automatic control includes at least one pressure switch for determining if the pressure in an air reservoir used for vehicular braking is below a predetermined level and for preventing use of the blast wiper system to enable the vehicle's air braking system to remain operative.

2. An air blast system as in claim 1, wherein the at least one marker light is comprised of at least one light emitting diode (LED).

3. An air blast system as in claim 1, further comprising
an optional reservoir mounted in-line with the air distribution supply tubing for facilitating the application of fluid, to the at least one marker light.

4. An air blast system as in claim 3, wherein the liquid is an anti-freeze fluid.

5. An air blast system as in claim 3, further comprising: wherein the fluid works to assist in the removal of accumulated debris on the vehicle.

6. An air blast system as in claim 1, further comprising a manual override of the automatic control for providing a substantially instantaneous blast of air regardless of a control cycle.

7. An air blast system as in claim 1, wherein the air blast wiper system is a preassembled kit for installation on a vehicle.

8. An air blast wiper system for removing environmental residue from the surface of a lens of a marker light used for vehicular lighting comprising:
an automatic control system for regulating a flow of air from the air reservoir into predetermined intermittent gushes of air;
supply tubing for distributing air from the automatic control at approximately a 30 degree angle relative to the surface of the lens;
at least one truncated conical nozzle for directing the intermittent gushes of air from the supply tubing toward a surface of the warning light for maintaining the warning light of the vehicle in a visible state when the vehicle is driving in a snowy condition; and
wherein the automatic control system includes at least one pressure switch for determining if the pressure in the air braking reservoir is below a predetermined level and for preventing use of the blast wiper system to enable the vehicle's air braking system to remain operative when pressure within the air reservoir is below a predetermined level.

9. An air blast system as in claim 8, wherein the at least one marker light is comprised of at least one light emitting diode (LED).

10. An air blast system as in claim 9, further comprising:
an optional reservoir mounted serially with the air distribution supply tubing for facilitating the application of fluid, to the marker light.

11. An air blast system as in claim 10, wherein the fluid is an alcohol based anti-freeze liquid.

12. An air blast system as in claim 10, wherein the fluid works to assist in the removal of accumulated environmental residue on the lens.

13. An air blast system as in claim 9, further comprising a manual override of the automatic control for providing a substantially instantaneous blast of air regardless of a control cycle.

14. An air blast system as in claim 9, wherein the air blast wiper system is a kit for installation on a vehicle.

15. An air blast wiper system for removing snow from a marker light lens surface used for vehicular lighting comprising:
a fluid reservoir for proving an anti-freeze fluid;
an automatic control system for regulating a flow of air from the air reservoir into predetermined intermittent gushes of air;
supply tubing for separately distributing air from a T-connector to an upper edge of a first lens and an upper edge of a second lens;
at least one truncated conical nozzle for directing the intermittent gushes of air and anti-freeze fluid from the supply tubing toward a surface of the first lens and second lens at approximately a 30 degree angle relative to the surface of the first lens and second lens to maintain the warning light of the vehicle in a visible state when the vehicle is driving in a snowy condition; and
wherein the automatic control system includes at least one pressure switch for determining if the pressure in the air reservoir used in the vehicle air braking system is below a predetermined level and for preventing use of the blast wiper system to enable the vehicle's air braking system to remain operative when pressure within the air reservoir is below a predetermined threshold.

16. An air blast wiper system as in claim 15, wherein the at least one marker light uses a light emitting diode (LED).

17. A method for removing snow from at least one marker light of a vehicle, comprising the step of:
utilizing an air reservoir on the vehicle used in connection with an air braking system;
connecting an automatic control system to the air reservoir for regulating a flow of air into predetermined intermittent gushes of air;
distributing air from the automatic control via supply tubing to at least one predetermined location on the vehicle;
directing the intermittent gushes of air from the supply tubing using at least one truncated nozzle toward a surface of a lens for maintaining the marker light of the vehicle in a visible state when the vehicle is driving in a snowy condition; and
providing the automatic control with at least one pressure switch for determining if the pressure in the air reservoir is below a predetermined level and for preventing use of the blast wiper system to enable the vehicle's air braking system to remain operative.

18. A method for removing snow as in claim 17, further comprising the step of:
utilizing a light emitting diode (LED) in the at least one marker light.

19. A method for removing snow as in claim 17, further comprising the step of:
providing the intermittent gushes of air at approximately a 30 degree angle relative to the lens.
